(19) United States
(12) Patent Application Publication
(10) Pub. No.: US 2016/0162959 A1
(43) Pub. Date: Jun. 9, 2016

(54) Performance Optimization Utilizing Pre-Analysis of Condition Records

(71) Applicants: Wilfried Merkel, Heidelberg (DE); Boris Krems, Reichartshausen (DE); Gururaj Raman, Heidelberg (DE); Thomas Veit, Kirchheimbolanden (DE)

(72) Inventors: Wilfried Merkel, Heidelberg (DE); Boris Krems, Reichartshausen (DE); Gururaj Raman, Heidelberg (DE); Thomas Veit, Kirchheimbolanden (DE)

(21) Appl. No.: 14/562,208

(22) Filed: Dec. 5, 2014

(51) Int. Cl. G06Q 30/02; G06F 17/30

(52) U.S. Cl. CPC G06Q 30/0283; G06F 17/30867; G06F 17/30339; G06F 17/30528

(57) ABSTRACT

A method includes receiving a request to perform pricing, determining relevant attributes as a subset of multiple pricing attributes by analyzing a pricing configuration, and deriving attribute value combinations based on relevant attributes to provide a reduced set of combinations to pricing. An optional method includes scanning corresponding condition tables for distinct values of each attribute to further reduce attribute value combinations on which to call pricing.

### BACKGROUND

Determining a price, a customer has to pay for a certain product, is a complicated process that requires a computer to perform. This is due to the fact, that in most cases such a price consists of several price elements, like e.g. a base price, surcharges, discounts, freights, taxes, etc., which have to be determined and calculated in the right order. A pricing module typically solves this task by using a pricing procedure, which controls the sequence and the calculation principles of the different price elements. But also the determination of each price element can be cumbersome. In some systems, like SAP, the price elements are represented by many different conditions contained in many condition tables indexed by variable keys in which e.g. a base price of each material may change depending on customer, volume ordered, weight ordered, delivery dates, methods of shipping, and many other factors. In other systems, e.g. rule based configurations might exist, which control the result for each price element. In all cases, the complexity described leads to significant runtimes for each call of the pricing module. Especially for scenarios where thousands of materials are involved, e.g. creating a price list for a specific customer, the overall runtime might be critical, that means there is a high performance demand for systems that execute pricing. Therefore, the major goal of this invention is to provide algorithms for avoiding unnecessary calls of the pricing module.

Most pricing modules are using pricing procedures for their inherited calculations. The aim of a pricing procedure is the automatic transfer of price elements, such as prices, customer discounts, customer group discounts, surcharges, and taxes, into a document or other form. Pricing generally takes place in generation of ordering and invoicing documents, but may also occur in the creation of sales documents, net price lists for a large number of customers and price inquires for internet scenarios. Price elements are factors with regard to each item or each of a quantity of an item being ordered or invoiced. However, there may also be price elements that are applicable to an order or invoice as a whole, such as sales tax, company discounts, and the like.

The price elements can be dependent on any number of conditions of a document, such as an order or invoice document, being created. For example, such conditions may simply include a product condition where a product has a single price. However, the other conditions may be dependent upon factors such as a customer identity, an affiliation of customer with a favored group, a geographic location of the customer (e.g. country specific pricing and local sales tax), one or more contracts or other agreements with the customer, a document date, a product quantity ordered or purchased, and the like.

Pricing may also typically be performed according to a defined sequence according to procedures that are logically defined. In some embodiments, a single procedure may be defined. However, in other embodiments, customers or groups of customers may be assigned specific or general pricing procedures.

Pricing elements may have many different factors for consideration in reaching a final price. Each of these factors may require a retrieval of data from a pricing data repository, such as a file or a database, commonly referred to as condition tables. As a result, each price element often requires multiple data retrievals. In a batch job invoice or order document generation scenario, the number of retrievals can be quite large, adding considerable time to execution of the batch job.

### BRIEF DESCRIPTION OF THE DRAWINGS

FIG. 1 is a logical block diagram of a system according to an example embodiment.

FIG. 2 is a diagram illustrating various attributes having sets of members according to an example embodiment.

FIG. 3 is a chart illustrating various relevant attribute combinations according to an example embodiment.

FIG. 4 is a chart illustrating various further relevant attribute combinations according to an example embodiment.

FIG. 5 is a chart illustrating various further relevant attribute combinations according to an example embodiment.

FIG. 6 is a chart illustrating condition tables and attribute sets according to an example embodiment.

FIG. 7 is a chart illustrating various attribute combinations and reduced number of combinations based on attribute value combinations according to an example embodiment.

FIG. 8 is a flowchart illustrating a method of optimizing performance of pricing according to an example embodiment.

FIG. 9 is a block diagram of a computer system for use in performing one or more methods and implementing systems according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

When creating price lists or price catalogs, net prices may be calculated for a range of customers (n) and a product assortment with (m) items. In a worst case, n×m price calculations may be performed. Sometimes groups of customers and materials are introduced and prices may be defined and calculated on a group level to reduce the complexity and number of calculations. However, many variables may be introduced such that additional attributes may be defined for customers, materials, organizations, dates, etc., further increasing the complexity of pricing calculations. A full set of pricing variables may be referred to as attributes. Attributes which are used may be referred to as relevant attributes. The attributes may correspond to variable keys, which are used to index condition tables used in the pricing calculations.

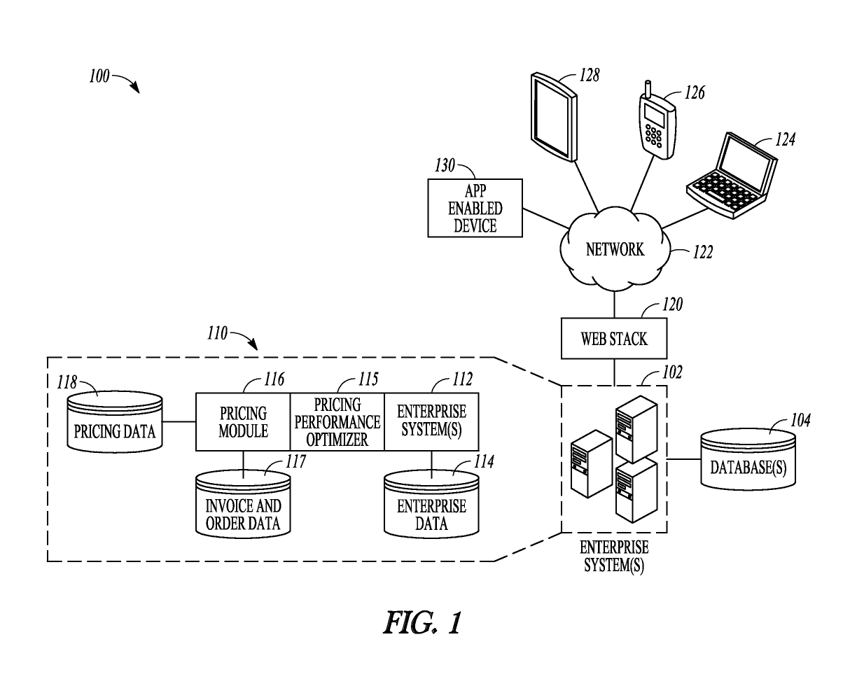

FIG. 1 is a logical block diagram of a system 100, according to an example embodiment. The system 100 typically includes at least one enterprise system 102 deployed on one or more servers. The enterprise system 102, in some embodiments, is an Enterprise Resource Planning (ERP) system, such as are available from SAP SE, of Walldorf, Germany. In other embodiments, in addition to an ERP system, the enterprise system may alternatively, or also, include one or more of a Customer Relationship Management (CRM) system, a Human Resources Management (HRM) system, an accounting and finance system, and other such systems.

The enterprise system 102 may store data in one or more databases 104. In some embodiments, the enterprise system 102 may include various elements 110. The elements of the enterprise system 102 may include one or more enterprise systems 112, such as are enumerated above. The elements may also include a pricing performance optimizer 115, and a pricing module 116 that is executable to price products and other items included in price quotes, orders, invoices, and other documents. The one or more databases 104 of the enterprise system 102 may include elements 110, such as an enterprise data database 114 that may store enterprise system 112 configuration data, master data, content, and transaction data. The one or more databases 104 may further include an invoicing and order data database 117 and a pricing data database 118. In some embodiments, all of the enterprise data database 114, invoicing data database 117, and pricing data database 118 may be included within the one or more databases 104 of the enterprise system 102.

The enterprise system 102 may also be connected to a network 122, either directly or via a web stack 120, such as a web server, an application server, and various other servers and networking devices. The enterprise system 102 may be connected to the network 122 to provide data processing services of the enterprise system 102 to users in a cloud-based arrangement. In other embodiments, the enterprise system 102 may provide access and data processing services of the enterprise system 102 and data stored thereby to users of personal computers 124, mobile devices such as smart phones 126 and tablets 128, and other app enabled devices 130. In some embodiments, pricing data may be generated by the pricing module 116 for inclusion in web pages or app data servicing communications sent via the network 122 in response to requests received therefrom. Additionally, the enterprise system 102 may generate invoices, order documents, pricing quotes, and other such documents in an electronic form and transmit them via the network 122.

In some embodiments, the network 122 is representative of one or both of wired and wireless networks. The wired and wireless networks may include one or more of each of a local area network, a wide area network, a system area network, a storage area network, a virtual private network, a value added network, a global data network, the Internet, and other such networks.

In some embodiments, the enterprise system 112 includes an invoice and order document generating process that may be called by other processes. Note however that the enterprise system 112 may include other or additional processes in different embodiments that may utilize the pricing optimization and functionality described herein. Thus, the described invoicing and order document generating process is one possible example of a process that utilizes the pricing functionality.

Typically, when a request is made to a pricing module to perform pricing, the request takes the form of a list of attributes and specifies an order or sequence in which the attributes should be applied to derive the price. Generally, pricing is a function of the customer and material. The maximum number of price calculations may be determined by the Cartesian product of all attribute value sets, referred to as the number of attributes and value set size. For instance, one attribute may be customer (C). The number of customers is the size of the customer attribute. Other attributes may include for example, distribution channel (DC), customer group (CG) material (M), material group (MG), etc. Many standard pricing attributes may be defined for use by the pricing module for the procedures used, and more may be defined by users in various embodiments, adding further complexity to the calculation of prices.

In one embodiment, an evaluation of actually used attributes in a user implementation provides a set of relevant attributes which is significantly reduced. This reduction results in the ability to use a much smaller set of attribute combinations and therefore a much smaller number of price calculations. The following two examples are provided to illustrate the reduction to a set of relevant attributes, followed by performance of the pricing function with the reduced set of relevant attributes.

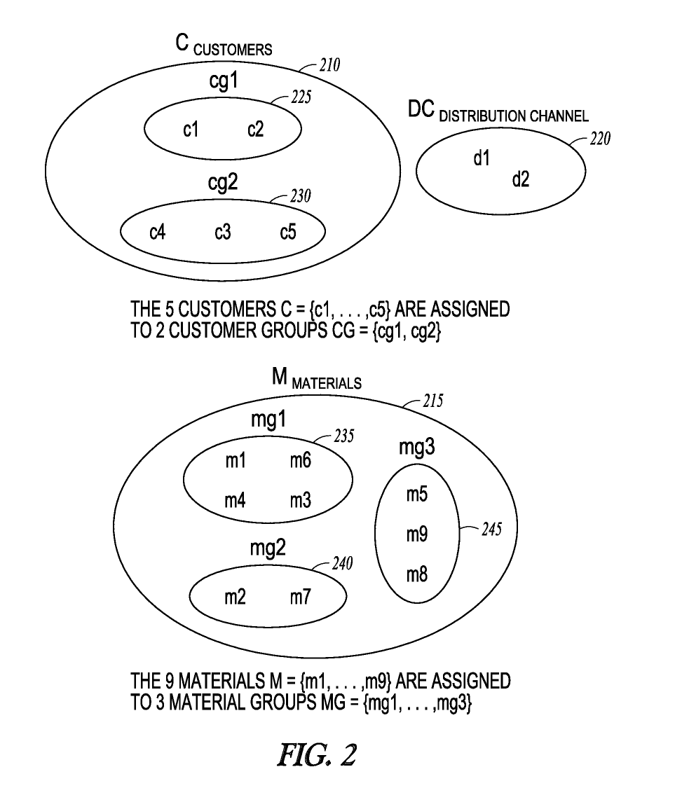

FIG. 2 illustrates an example showing attributes of customers 210, materials 215 and distribution channels 220. The customers attribute 210 illustrates a set of five customers, c1, c2, c3, c4, and c5. Some of the customers are grouped as indicated at 225 corresponding to group cg1 which includes customers c1 and c2. Group cg2 at 230 includes customers c3, c4, and c5. The materials attribute 215 has a set of nine different materials, m1-m9, with three groups. Group mg1 at 235 contains m1, m3, m4, and m6, group mg2 at 240 includes m2 and m7, and group mg3 at 245 includes m5, m8, and m9. Distribution channel 220 includes a set of two distribution channels d1 and d2.

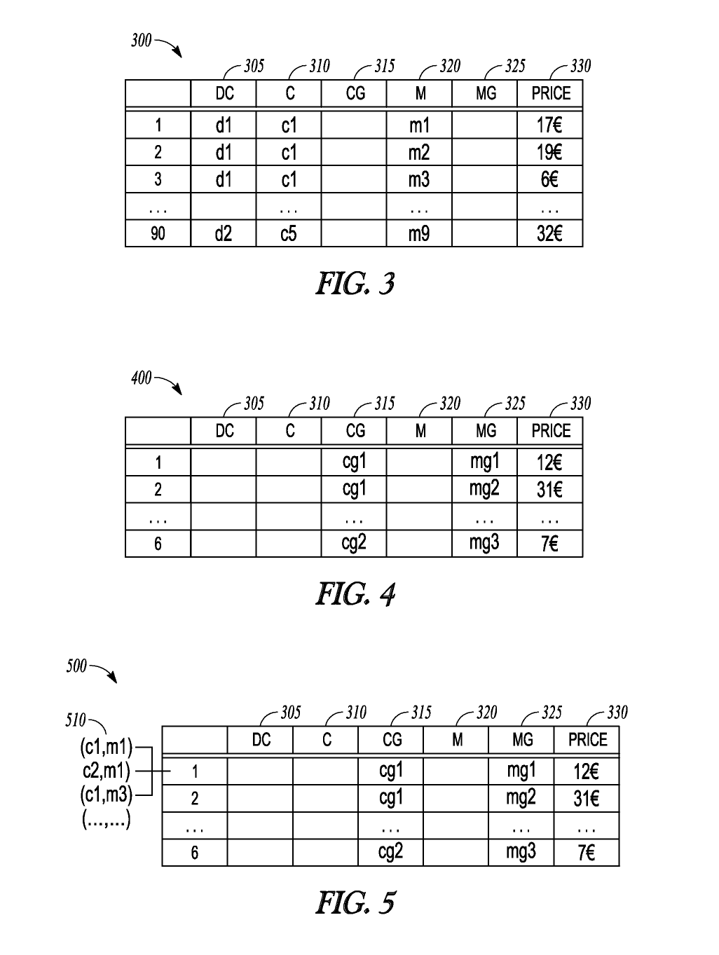

FIG. 3 is a chart 300 illustrating a first example of pricing performance optimization based on the attributes illustrated in FIG. 2 prior to calling a pricing module. Table 300 includes columns for distribution channel (DC) 305, customer (C) 310, customer group (CG) 315, material (M) 320, material group (MG) 325, and resulting price in euros at 330. In example 1, there are known to be three relevant attributes, distribution channel with two members of the set, customer with five members of the set, and material with nine members of the set. The product of 2*5*9 is 90. (Note that “*” is used as a multiplication symbol.) There are thus 90 rows in the chart 300 corresponding to all the pricing permutations. Note that in some examples, with thousands of materials and thousands of customers, the number of permutations and hence calculations for the pricing procedure can run well into the millions, resulting in accesses to multitudes of condition tables during pricing.

FIG. 4 is a chart 400 illustrating a second example of pricing performance optimization prior to calling a pricing module. Based on the same attributes as illustrated in FIG. 2, this time the relevant attributes are customer group, having a set of three members, and distribution channel, having a set of two members for a total of 6 permutations corresponding to six rows in the chart 400. Thus, while there are still five customers and nine materials with two distribution channels for a total of 90 possible calculations, it is sufficient to perform only six calculations based on the grouping of customer and materials to perform pricing.

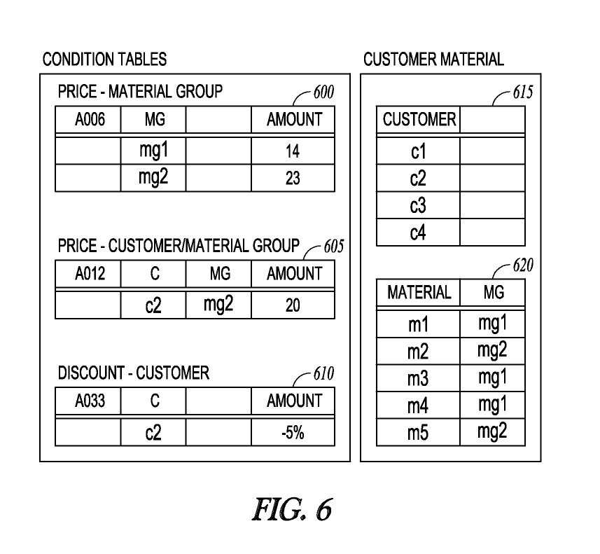

FIG. 5 is a chart 500 illustrating a third example where pricing for multiple items in a document or for a price list or price inquiry utilizes a single call to the pricing module by reusing pricing results. In FIG. 5, the customer group 315 and material group 325 are again the relevant attributes.

For customer c1 and material m4, and some other customer/material items, the same tupel (attribute value combination cg1/mg1) is derived as for c1/m1. The pricing module is called only once for the tuple cg1/mg1 and the result reused in the respective customer/material items c1/m1, c2/m1, c1/m3, c2/m3, c1/m4, c2/m4, c1/m6, c2/m6 as indicated at 510. Instead of 8 calculations (for customers c1/c2 and materials m1/m3/m4/m6) only 1 calculation is sufficient.

When calculating the price for customer c1 and material m1, the tupel (cg1/mg1) is derived and the pricing module is called with this attribute combination. For customer c1 and material m4 the same attribute value combination is derived and therefore the pricing result is simply reused.

In a further embodiment, the number of calculations and accesses for a set of customer-material combinations can be reduced further through the analysis of condition records. All affected condition tables may be scanned by selecting the distinct values of the most-selective relevant attributes one after the other. In some embodiments, such analysis may not be done for all relevant attributes since some of them might be not so selective so that there would be a drawback due to analysis performance costs and administrative memory demand. In further embodiments, scanning may be performed on any database persistency allowing retrieval of distinct values of an attribute.

The set of distinct values used in condition records for these attributes may be smaller. For example, in some instances, specific prices may be defined for only 10% of the customers. The attribute “customer” may only be filled in a data structure when there is at least one condition record with this value. Otherwise the attribute stays empty. This reduces the number of tuples further.

Before the pricing module is called, it is checked whether there would be “duplicate” entries passed to pricing. If so, these entries are bundled to one pricing item. Thus, only items which are “non-identical” from a pricing point-of-view are passed to pricing as illustrated in the following examples 4 and 5.

In an example 4, customer is configured as an attribute with 12,000 set members. In other words, there are 12,000 customers. Every customer is assigned to one of three customer groups and prices are maintained for these groups. Only for 980 of those customers individual condition records are maintained. For all other customer IDs the system will not find any record with these IDs. In these cases the customer ID is irrelevant, thus has not to be passed to pricing and will not be filled in the attribute tupel. Instead for these customer IDs a group price will be calculated. For all of these customer IDs 1 of 3 different customer group prices can just be reused. So instead of 12,000*×(materials) calculations there are only (3+980)*×(materials) calculations necessary.

FIG. 6 illustrates some example condition tables 600, 605, and 610 for attributes customer 615 and material 620. Condition table 600 provides price for a set of material groups. Condition table 605 provides an amount for a customer and material group, and condition table 610 provides a discount for a customer. There are four customers in the customer attribute 615 and five materials in the material attribute 620.

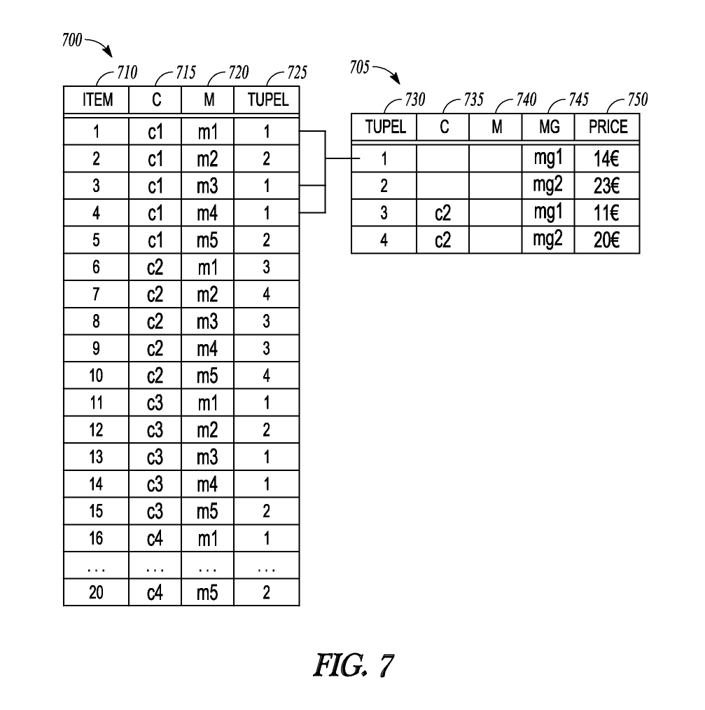

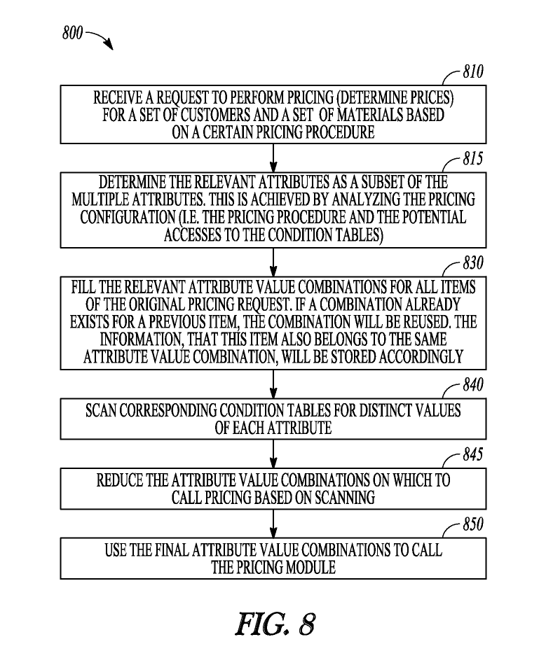

Example 5 relies on FIG. 6 and is further illustrated in FIG. 7 with charts 700 and 705. For Customers c1-c4, prices are calculated for materials m1-m5 as illustrated in the 20 rows of chart 700. Chart 700 includes columns for item 710, customer 715, material 720, and tupel 725. Chart 705 includes columns for tupel 730, customer 735, material 740, material group 745, and price 750.

A pricing module may include a configuration, referred to as a pricing configuration, which is usually created at design time to set up calculation principles. In one embodiment, the pricing configuration is created by defining a pricing procedure, assigning pricing elements to this procedure and setting up pricing access sequences for each pricing element, which control the accesses to the condition tables. In other embodiments, this might be achieved by setting up certain rules like e.g. “IF . . . THEN . . . ” upfront.

By analyzing the pricing configuration it is found out that there are 2 relevant attributes (customer 735 and material group 745) defined. The number of attribute value combinations and thus the maximum number of different Prices which can be calculated is |C|*|MG|=4*2=8. Thus instead of 20 calculations for the customer material combinations only 8 calculations have to be performed.

The scan through all condition tables for the distinct values of customer ID returns only the ID c2. The attribute customer will only be filled in the tupel for customer c2. Otherwise the attribute stays empty. This reduces the number of tuples further. In example 5, the number of calculations is reduced again from 8 to 4. For 20 customer material combinations, just 4 calculations are sufficient to perform pricing.

Although the previous examples are based on entities like condition tables etc., which are typical for the SAP implementation of a pricing module, the principles described are also valid for any other pricing module. E.g. also the performance of any rule-based pricing module might benefit from a similar pre-pricing analysis, as long as the pricing module is able to provide the required information upfront, like “for which customer IDs do customer specific prices exist?” In other words, if a specific price does not exist for the customer, an attribute for the customer is not relevant and need not be filled.

FIG. 8 is a flowchart illustrating a method 800 corresponding to the previous examples. The method 800 in one embodiment may be implemented as a process or procedure of the enterprise system 112 as illustrated at pricing performance optimization block 115 in FIG. 1. Method 800 receives a request to perform pricing (determine prices) for a set of customers and a set of materials based on a certain pricing procedure at 810. The request may identify multiple attributes for use by the pricing module to access values in condition records. At 815, relevant attributes are determined as a subset of the multiple attributes. To determine the relevant attributes in one embodiment, the configuration of the pricing module is analyzed accordingly. In one embodiment, e.g. SAP ERP (Enterprise Resource Planning), this can be done by analyzing the pricing procedure and the key fields used for all potential accesses to condition tables.

The relevant attributes comprise customer, material, and distribution channel in one embodiment, and may further include customer group and material group. The customer group may include multiple different groups of customers and the material group may include multiple different groups of materials.

At 830, method 800 will derive the relevant attribute value combinations for all items of the original pricing request. If a combination already exists for a previous item, the existing combination will be reused. That means, there is a 1:n mapping between items and relevant attribute value combinations, which is kept by the system.

Method 800 may further include scanning corresponding condition tables for distinct values of each attribute at 840 and reducing attribute value combinations on which to call pricing based on the scanning at 845.

At 850 the final set of attribute value combinations will be passed to the pricing module. After the pricing module returns the pricing result, the mapping between items and relevant attribute value combinations will be used, to assign the pricing result to the corresponding items.

The method 800 in one embodiment may perform the scanning for multiple most-selective relevant attributes to ensure efficient performance costs and system memory demand. In various embodiments, different combinations of elements in FIG. 8 may be performed with some elements not being performed. Various embodiments provide for pre pricing analysis of pricing condition records, which can reduce the processing and data access demands of a pricing procedure once the pricing procedure is invoked.

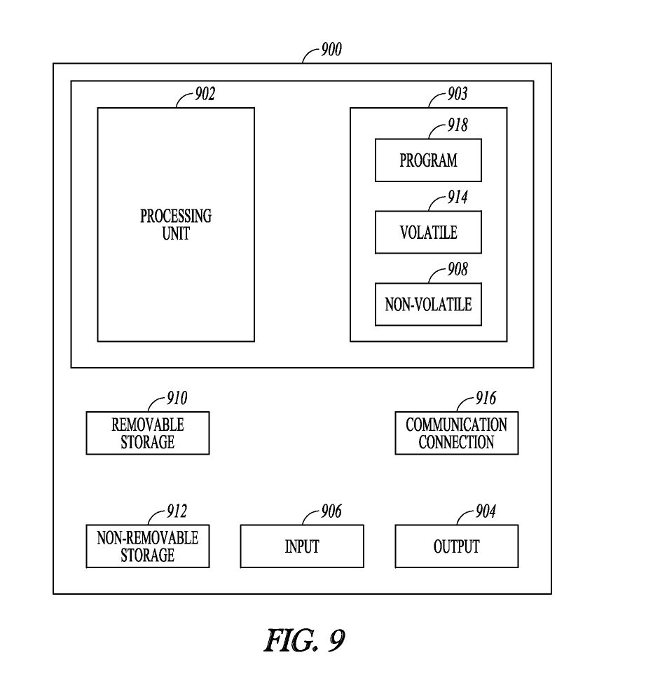

FIG. 9 is a block schematic diagram of a computer system 900 to implement methods and systems according to example embodiments. All components need not be used in various embodiments. One example computing device in the form of a computer 900, may include a processing unit 902, memory 903, removable storage 910, and non-removable storage 912. Although the example computing device is illustrated and described as computer 900, the computing device may be in different forms in different embodiments. For example, the computing device may instead be a smartphone, a tablet, smartwatch, or other computing device including the same or similar elements as illustrated and described with regard to FIG. 9. Devices such as smartphones, tablets, and smartwatches are generally collectively referred to as mobile devices. Further, although the various data storage elements are illustrated as part of the computer 900, the storage may also or alternatively include cloud-based storage accessible via a network, such as the Internet.

Memory 903 may include volatile memory 914 and non-volatile memory 908. Computer 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input 906, output 904, and a communication connection 916. Output 904 may include a display device, such as a touchscreen, that also may serve as an input device. The input 906 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 902 of the computer 900. A hard drive, CD-ROM, and RAM are some examples of articles including a non-transitory computer-readable medium such as a storage device. The terms computer-readable medium and storage device do not include carrier waves. For example, a computer program 918 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 900 to provide generic access controls in a COM based computer network system having multiple users and servers.

### Further Examples

1. A method comprising:
receiving a request to perform pricing;
determining relevant attributes as a subset of multiple pricing attributes by analyzing a pricing configuration; and
deriving attribute value combinations based on relevant attributes to provide a reduced set of combinations to pricing.
2. The method of example 1 wherein the relevant attributes are identified based on the attributes used in the request to determine prices.
3. The method of any of examples 1-2 wherein the relevant attributes comprise customer, material, and distribution channel.
4. The method of any of examples 1-3 wherein the relevant attributes comprise customer group and material group, wherein the customer group includes multiple different groups of customers and the material group comprises multiple different groups of materials.
5. The method of any of examples 1-4 and further comprising: checking for relevant attribute value combinations in the request; and using a pricing result for one attribute value combination for multiple other same attribute value combinations without calling the pricing procedure again.

6. The method of claim 5 wherein identifying relevant attributes comprises analyzing the request, wherein the request includes a pricing configuration, to reduce attribute value combinations, the method further comprising:
scanning corresponding condition tables for distinct values of each attribute; and
reducing attribute value combinations on which to call pricing based on the scanning
7. The method of any of examples 1-6 wherein identifying relevant attributes comprises analyzing the request, wherein the request includes a pricing configuration, to reduce attribute value combinations, the method further comprising:
scanning corresponding condition tables for distinct values of an attribute; and
reducing attribute value combinations on which to call pricing based on the scanning
8. The method of example 7 wherein scanning is performed on any database persistency allowing retrieval of distinct values of an attribute.
9. The method of any of examples 7-8 wherein scanning is performed for multiple most-selective relevant attributes to ensure efficient performance costs and system memory demand.
10. A machine readable storage device having instructions for execution by a processor of the machine to perform actions comprising:
receiving a request to perform pricing, the request identifying multiple attributes for use by pricing;
determining relevant attributes as a subset of the multiple attributes by analyzing a pricing configuration; and
deriving attribute value combinations based on relevant attributes to provide a reduced set of combinations to pricing.
11. The machine readable storage device of example 10 wherein the relevant attributes comprise customer, material, and distribution channel.
12. The machine readable storage device of any of examples 10-11 wherein the relevant attributes comprise customer group and material group, wherein the customer group includes multiple different groups of customers and the material group comprises multiple different groups of materials.
13. The machine readable storage device of any of examples 10-12 wherein the actions further comprise:
checking for relevant attribute value combinations in the request; and using a pricing result for one attribute value combination for multiple other same attribute value combinations without calling the pricing procedure again.
14. The machine readable storage device of claim 13 wherein identifying relevant attributes comprises analyzing the request, wherein the request includes the pricing configuration, to reduce attribute value combinations, the actions further comprising:
scanning corresponding condition tables for distinct values of each attribute; and
reducing attribute value combinations on which to call pricing based on the scanning
15. The machine readable storage device of any of examples 10-14 wherein identifying relevant attributes comprises analyzing the request, wherein the request includes the pricing configuration, to reduce attribute value combinations, the actions further comprising:
scanning corresponding condition tables for distinct values of an attribute; and
reducing attribute value combinations on which to call pricing based on the scanning
16. The machine readable storage device of example 15 wherein scanning is performed for multiple most-selective relevant attributes to ensure efficient performance costs and system memory demand.
17. A device comprising:
a processor; and
a memory device coupled to the processor and having a program stored thereon for execution by the processor to:
   receive a request to perform pricing, the request identifying multiple attributes for use by pricing;
   determining relevant attributes as a subset of the multiple attributes by analyzing a pricing configuration; and
   call the pricing procedure using the identified relevant attributes to eliminate accessing of non-relevant condition records.
18. The device of example 17 wherein the relevant attributes are identified based on the attributes used in the request to determine prices, the relevant attributes comprising customer, material, and distribution channel.
19. The device of any of examples 17-18 wherein the processor further:
checks for relevant attribute value combinations in the request; and uses a pricing result for one attribute value combination for multiple other same attribute value combinations without calling the pricing procedure again.
20. The device of example 19 wherein identifying relevant attributes comprises analyzing the request, wherein the request includes a pricing configuration, to reduce attribute value combinations, wherein the processor further:
scans corresponding condition tables for distinct values of each attribute; and
reduces attribute value combinations on which to call pricing based on the scanning.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
receiving a request to perform pricing via a computer coupled to a database;
determining relevant attributes as a subset of multiple pricing attributes by analyzing a pricing configuration; and
deriving attribute value combinations based on relevant attributes to provide a reduced set of combinations to pricing.

2. The method of claim 1 wherein the relevant attributes are identified based on the attributes used in the request to determine prices.

3. The method of claim 1 wherein the relevant attributes comprise customer, material, and distribution channel.

4. The method of claim 1 wherein the relevant attributes comprise customer group and material group, wherein the customer group includes multiple different groups of customers and the material group comprises multiple different groups of materials.

5. The method of claim 1 and further comprising:
checking for relevant attribute value combinations in the request; and
using a pricing result for one attribute value combination for multiple other same attribute value combinations without calling the pricing procedure again.

6. The method of claim 5 wherein identifying relevant attributes comprises analyzing the request, wherein the request includes a pricing configuration, to reduce attribute value combinations, the method further comprising:
scanning corresponding condition tables for distinct values of each attribute; and
reducing attribute value combinations on which to call pricing based on the scanning.

7. The method of claim 1 wherein identifying relevant attributes comprises analyzing the request, wherein the request includes a pricing configuration, to reduce attribute value combinations, the method further comprising:
scanning corresponding condition tables for distinct values of an attribute; and
reducing attribute value combinations on which to call pricing based on the scanning.

8. The method of claim 7 wherein scanning is performed on any database persistency allowing retrieval of distinct values of an attribute.

9. The method of claim 7 wherein scanning is performed for multiple most-selective relevant attributes to ensure efficient performance costs and system memory demand.

10. A machine readable storage device having instructions for execution by a processor of the machine to perform actions comprising:
receiving a request to perform pricing, the request identifying multiple attributes for use by pricing;
determining relevant attributes as a subset of the multiple attributes by analyzing a pricing configuration; and
deriving attribute value combinations based on relevant attributes to provide a reduced set of combinations to pricing.

11. The machine readable storage device of claim 10 wherein the relevant attributes comprise customer, material, and distribution channel.

12. The machine readable storage device of claim 10 wherein the relevant attributes comprise customer group and material group, wherein the customer group includes multiple different groups of customers and the material group comprises multiple different groups of materials.

13. The machine readable storage device of claim 10 wherein the actions further comprise:
checking for relevant attribute value combinations in the request; and
using a pricing result for one attribute value combination for multiple other same attribute value combinations without calling the pricing procedure again.

14. The machine readable storage device of claim 13 wherein identifying relevant attributes comprises analyzing the request, wherein the request includes the pricing configuration, to reduce attribute value combinations, the actions further comprising:
scanning corresponding condition tables for distinct values of each attribute; and
reducing attribute value combinations on which to call pricing based on the scanning.

15. The machine readable storage device of claim 10 wherein identifying relevant attributes comprises analyzing the request, wherein the request includes the pricing configuration, to reduce attribute value combinations, the actions further comprising:
scanning corresponding condition tables for distinct values of an attribute; and
reducing attribute value combinations on which to call pricing based on the scanning.

16. The machine readable storage device of claim 15 wherein scanning is performed for multiple most-selective relevant attributes to ensure efficient performance costs and system memory demand.

17. A device comprising:
a processor; and
a memory device coupled to the processor and having a program stored thereon for execution by the processor to:
receive a request to perform pricing, the request identifying multiple attributes for use by pricing;
determining relevant attributes as a subset of the multiple attributes by analyzing a pricing configuration; and
call the pricing procedure using the identified relevant attributes to eliminate accessing of non-relevant condition records.

18. The device of claim 17 wherein the relevant attributes are identified based on the attributes used in the request to determine prices, the relevant attributes comprising customer, material, and distribution channel.

19. The device of claim 17 wherein the processor further:
checks for relevant attribute value combinations in the request; and
uses a pricing result for one attribute value combination for multiple other same attribute value combinations without calling the pricing procedure again.

20. The device of claim 19 wherein identifying relevant attributes comprises analyzing the request, wherein the request includes a pricing configuration, to reduce attribute value combinations, wherein the processor further:
scans corresponding condition tables for distinct values of each attribute; and
reduces attribute value combinations on which to call pricing based on the scanning.
